(19) United States
(12) Patent Application Publication
(10) Pub. No.: US 2024/0071162 A1
(43) Pub. Date: Feb. 29, 2024

(54) AUTOMATED TRANSACTION MACHINE

(71) Applicant: Diebold Nixdorf, Incorporated, Hudson, OH (US)

(72) Inventors: Todd Christian, Dalton, OH (US); Nate Oberly, East Canton, OH (US); Bernd Steffens, Paderborn (DE); Gregor Pollman, Paderborn (DE); Erich Kujat, Paderborn (DE); Andrea Carozzi, Delbrueck (DE); Alexander Uhl, Paderborn (DE); Ulrich Neumann, Lippstadt (DE); Tobias Schlitt, Paderborn (DE)

(21) Appl. No.: 18/237,445

(22) Filed: Aug. 24, 2023

Related U.S. Application Data
(60) Provisional application No. 63/400,433, filed on Aug. 24, 2022.

(51) Int. Cl. G07D 11/16; B65H 5/28; G07D 11/125; G07D 11/14; G07D 11/40

(52) U.S. Cl. CPC G07D 11/16; B65H 5/28; G07D 11/125; G07D 11/14; G07D 11/40; B65H 2301/41922; B65H 2701/1912; G07D 2211/00

(57) ABSTRACT

An automated transaction machine (“ATM”) can include a note input/output port, an escrow unit, and an upper transport. The escrow unit can receive and hold currency notes. The upper transport can transport currency notes among the note input/output port and the escrow unit. The escrow unit can include a drum and first and second web-supply spool assemblies. The drum collects and releases currency notes relative to the upper transport, is rotatable about a first axis, and has a variable radius including minimum and maximum radii. Each web-supply spool assembly includes a spool and a web and can rotate about respective second and third axis parallel to and spaced from the first axis. A fourth axis can extend normal to and intersect both of the second and third axis and can be closer to the first axis than the maximum radius of the drum.

### CROSS-REFERENCE TO RELATED APPLICATIONS

This application claims the priority benefit of U.S. Provisional Patent Application Ser. No. 63/400,433 for an AUTOMATED TRANSACTION MACHINE, filed on 24 Aug. 2022, which is hereby incorporated by reference in its entirety.

### BACKGROUND

### 1. Field

The present disclosure relates to an automated transaction machine.

### 2. Description of Related Prior Art

U.S. Pat. Pub. No. 20210381300 discloses a SLIM PROFILE SAFE. The slim-profile safe has a safe body that defines an interior space, and a safe door that is moveable between a closed position for securing the interior space and an open position for accessing the interior space. The safe door includes a fore portion and a recess portion that is offset from the fore portion by a recess angle. The fore portion defines a maximum depth of the safe, and the recess portion provides a reduced depth portion of the safe for the presentation of external hardware for operating a lock that releasably locks the safe door in the closed position, the recess portion being sufficiently offset from the fore portion such that the external hardware is positioned entirely sub-flush to a plane that extends parallel to the fore portion.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

An automated transaction machine (“ATM”) can include a first currency note input/output port, an escrow unit, and an upper transport. The escrow unit can be configured to receive and hold currency notes. The upper transport can be configured to transport currency notes to and from the first currency note input/output port and to and from the escrow unit. The escrow unit can include a drum, a first web-supply spool assembly, and a second web-supply spool assembly. The drum can be configured to collect currency notes received from the upper transport and release collected currency notes to the upper transport. The drum can be rotatable about a first axis. The drum can have a variable radius including a minimum radius when no currency notes are collected on the drum and a maximum radius when a maximum amount of currency notes are collected on the drum. The first web-supply spool assembly can include a first web-supply spool and first web wound around the first web-supply spool. The first web-supply spool can be configured to rotate about a second axis parallel to and spaced from the first axis. The first web-supply spool assembly can be configured to rotate in unison with the drum whereby the first web is unwound from the first web-supply spool and wound around the drum to overlay currency notes as currency notes are collected on the drum and whereby the first web is wound on the first web-supply spool and unwound from the drum as currency notes are removed from the drum. The second web-supply spool assembly can include a second web-supply spool and second web wound around the second web-supply spool. The second web-supply spool can be configured to rotate about a third axis parallel to and spaced from the second axis. The second web-supply spool assembly can be configured to rotate in unison with the drum whereby the second web is unwound from the second web-supply spool and wound around the drum and overlay currency notes as currency notes are collected on the drum and whereby the second web is wound on the second web-supply spool and unwound from the drum as currency notes are removed from the drum. A fourth axis can extend normal to and intersect both of the second axis and the third axis and can be closer to the first axis than the maximum radius of the drum.

According to other features, the fourth axis can be closer to the first axis than the minimum radius of the drum. The escrow unit can be positioned above the upper transport and the fourth axis can extend fully horizontally. Alternatively, the escrow unit can be positioned behind the upper transport and the fourth axis can extend fully vertically. Alternatively, the escrow unit can be positioned above the upper transport and the fourth axis can extend both vertically and horizontally.

In other features, the escrow unit is positioned behind the upper transport and the fourth axis extends both vertically and horizontally. The first axis can be positioned closest to the upper transport among the first axis and the second axis and the third axis. Alternatively, the first axis can be positioned further from the upper transport than at least one of the second axis and the third axis.

According to additional features, the ATM can also include a belt interconnecting the first web-supply spool assembly and the second web-supply spool assembly for concurrent rotation.

An ATM can include a framework, a housing, a fascia, a display, a first currency note input/output port, a door, a plurality of cassettes, a second currency note input/output port, a lower transport, an escrow unit, and an upper transport. The framework can include a horizontal wall. The housing can be mounted on the framework and can extend vertically along a height axis between a top and a bottom. The housing can extend horizontally along a depth axis between a front and a back. The housing can extend horizontally along a width axis between a first lateral side and a second lateral side. The fascia can be mounted on the framework and can cooperate with the horizontal wall to define an upper portion of an interior of the ATM. The display can be positioned in a first aperture of the fascia. The first currency note input/output port can be positioned in a second aperture of the fascia. The door can be mounted on the framework and can cooperate with the horizontal wall to define a lower portion of the interior as well as a safe of the ATM. The plurality of cassettes can be positioned in the safe. The second currency note input/output port can extend through the horizontal wall. The lower transport can be positioned in the safe and can be configured to transport currency notes between the second currency note input/output port and the plurality of cassettes. The escrow unit can be configured to receive and hold currency notes. The upper transport can be positioned in the upper cavity and can be configured to transport currency notes to and from the first currency note input/output port, to and from the second currency note input/output port, and to and from the escrow unit. The escrow unit can include a drum, a first web-supply spool assembly, and a second web-supply spool assembly. The drum can be configured to collect currency notes received from the upper transport and release collected currency notes to the upper transport. The drum can be rotatable about a first axis. The drum can have a variable radius including a minimum radius when no currency notes are collected on the drum and a maximum radius when a maximum amount of currency notes are collected on the drum. The first web-supply spool assembly can include a first web-supply spool and first web wound around the first web-supply spool. The first web-supply spool can be configured to rotate about a second axis parallel to and spaced from the first axis. The first web-supply spool assembly can be positioned adjacent to the drum and can be configured to rotate in unison with the drum whereby the first web is unwound from the first web-supply spool and wound around the drum and overlay currency notes as currency notes are collected on the drum and whereby the first web is wound on the first web-supply spool and unwound from the drum as currency notes are removed from the drum. The second web-supply spool assembly can include a second web-supply spool and second web wound around the second web-supply spool. The second web-supply spool can be configured to rotate about a third axis parallel to and spaced from the second axis. The second web-supply spool assembly can be positioned adjacent to the drum and can be configured to rotate in unison with the drum whereby the second web is unwound from the second web-supply spool and wound around the drum and overlay currency notes as currency notes are collected on the drum and whereby the second web is wound on the second web-supply spool and unwound from the drum as currency notes are removed from the drum. A fourth axis can extend normal to and intersect both of the second axis and the third axis. The fourth axis can be closer to the first axis than the maximum radius of the drum.

In other features, the escrow unit can be positioned above the upper transport and the fourth axis can extend parallel to the depth axis. Alternatively, the fourth axis extends transverse to the depth axis. Alternatively, the escrow unit can be positioned behind the upper transport along the depth axis and the fourth axis can extend parallel to the height axis. Alternatively, the fourth axis extends transverse to the height axis.

According to additional features, the ATM can also include a receipt printer positioned above the upper transport in the upper portion of the interior. The escrow unit can be positioned above the upper transport and below the receipt printer. The first axis can be positioned closest to the lower transport among the first axis and the second axis and the third axis. Alternatively, the first axis can be positioned further from the lower transport than at least one of the second axis and the third axis.

According to other features, the ATM can also include a motor. The motor can be configured to drive the drum and the first web-supply spool and the second web-supply spool. The motor can be centered on a fifth axis. The fifth axis can be further from the first axis than the maximum radius of the drum.

### BRIEF DESCRIPTION OF THE DRAWINGS

The detailed description set forth below references the following drawings:

FIG. 1 is an isometric view of an ATM according to a first exemplary embodiment of the present disclosure from a front and left perspective;

FIG. 2 is a front orthogonal view of the first exemplary ATM;

FIG. 3 is a cross-sectional view of the first exemplary ATM, less some components thereof, taken in the direction of perspective arrow 3 shown in FIGS. 1 and 2;

FIG. 4 includes side views of two upper transports configured to move currency notes that can each be a subassembly of one or more embodiments of the present disclosure and also includes a side view of an upper transport according to the prior art;

FIG. 5 is an isometric view of an ATM according to a second exemplary embodiment of the present disclosure from a front and left perspective;

FIG. 6 is a side view of another exemplary upper transport configured to move currency notes that can be a subassembly of an ATM according to one or more embodiments of the present disclosure;

FIG. 7 is a enlarged portion of FIG. 6 showing an exemplary escrow unit in greater detail;

FIG. 8 is a side view of another exemplary upper transport configured to move currency notes that can be a subassembly of an ATM according to one or more embodiments of the present disclosure; and

FIG. 9 is a enlarged portion of FIG. 8 showing an exemplary escrow unit in greater detail.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

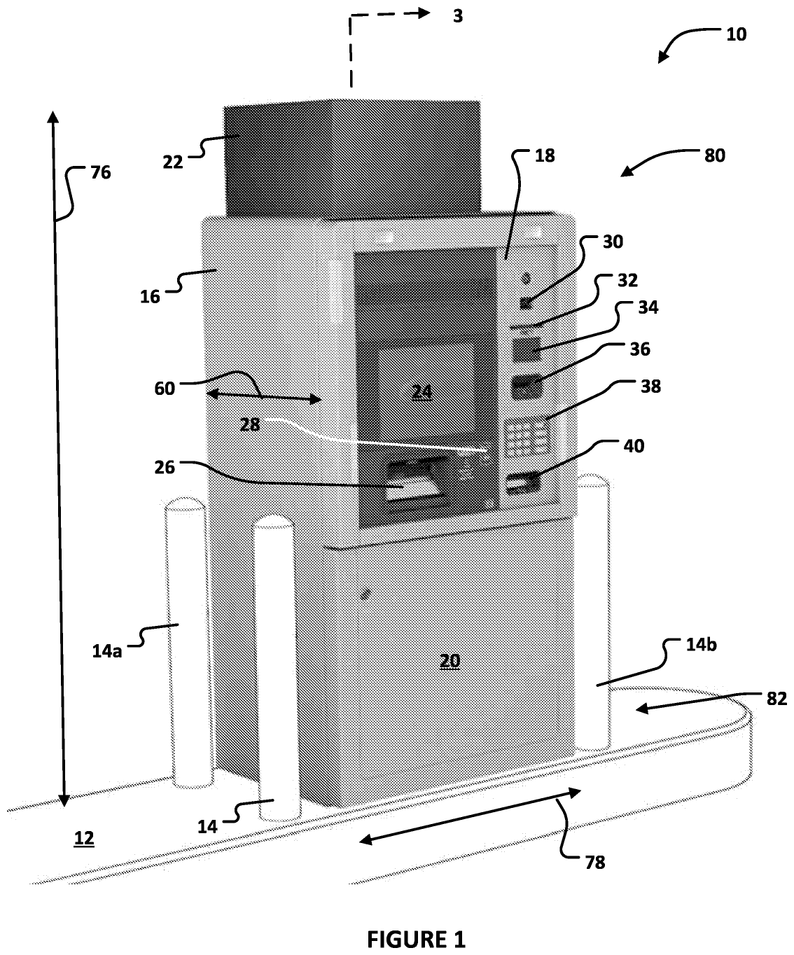

The present disclosure, as demonstrated by the exemplary embodiments described below, can provide a relatively shallow (minimized depth) automated transaction machine (ATM). As shown in FIG. 1, an exemplary ATM 10 has a depth 60. The exemplary ATM 10 has a height 76. The exemplary ATM 10 has a width 78.

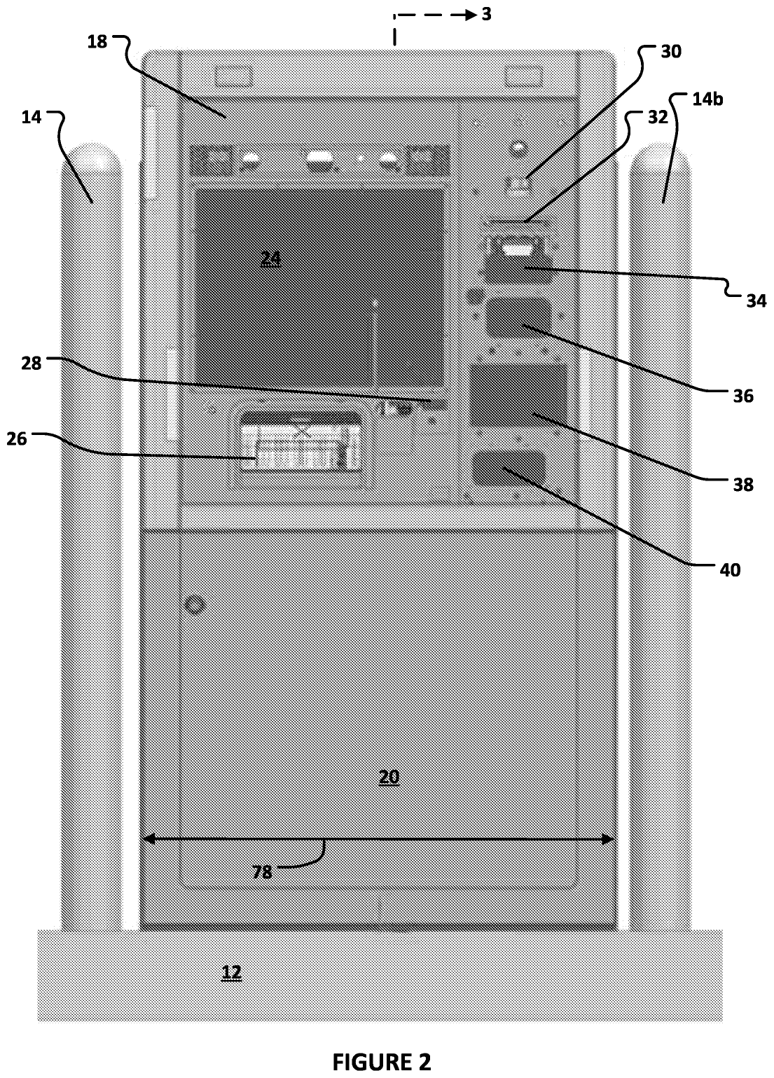

Referring now to FIGS. 1-3, the exemplary ATM 10 rests on an exemplary island 12 that is twenty-four inches wide and is protected by bollards 14, 14a, 14b. The ATM 10 can replace and/or be utilized in the place of a vacuum-assist tube arrangement. The exemplary ATM 10 includes an interior framework 13, a housing 16, a fascia 18, a front door 20, and a heater and air conditioner (“HVAC unit”) 22. The exemplary framework 13 can be a relatively robust structure formed from steel and/or concrete. The exemplary housing 16 can be mounted on the framework 13 and can extend vertically between a top 80 and bottom 82. The exemplary fascia 18 and door 20 can also be mounted on the framework 13. The exemplary framework 13 includes a horizontal wall 84 dividing an interior of the ATM enclosed by the framework 13, the housing 16, the facia 18, and the door 20 into an upper portion 86 and a lower portion 88. The exemplary housing 16 and fascia 18 can contain components of a top or upper portion of the ATM 10. The exemplary housing 16 and front door 20 can contain components of a bottom or lower portion of the ATM 10. The exemplary ATM 10 can also include a rear door (not visible based on the perspectives of FIGS. 1 and 2) providing access to the upper portion of the ATM 10 by a service technician. The HVAC unit 22 can provide cool air to the interior of the ATM 10 during periods of relatively high temperature and can provide warm air to the interior of the ATM 10 during periods of relatively low temperature.

The exemplary ATM 10 also includes a display 24 is positioned in and visible through an aperture in the fascia 18. The exemplary ATM 10 also includes a currency note input/output port 26 positioned in and therefore accessible through another aperture in the fascia 18. The exemplary ATM 10 also includes a near field communication (NFC) transmitter positioned behind the fascia 18 at a location referenced at 28.

The exemplary ATM 10 also includes a barcode and/or quick response (QR) code reader 30 accessible through an aperture in the fascia 18. The exemplary ATM 10 also includes a slot 32 in the fascia 18 through which receipts can be provided to a user of the ATM 10. The exemplary ATM 10 also includes an identification card reader 34 accessible through an aperture in the fascia 18.

The exemplary ATM 10 also includes a slot 36 in the fascia 18 through which a user can insert a bank card to be assessed by a card reader and receive the card back after the card has been assessed. The exemplary ATM 10 also includes a pin pad 38 accessible through another aperture in the fascia 18. The exemplary ATM 10 also includes a slot 40 in the fascia 18 through which a user can insert a bank check to be assessed by a check scanner and receive the check back if the check cannot be processed by the ATM 10.

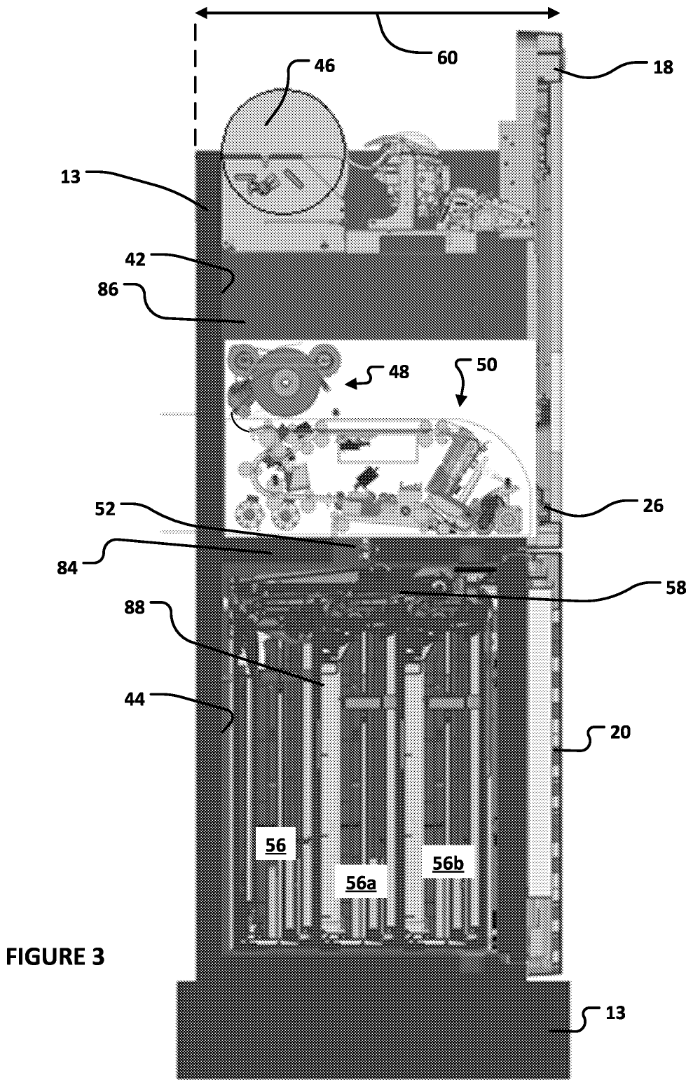

Referring now to FIG. 3, an upper cavity of the exemplary ATM 10 is referenced at 42 and the lower cavity is referenced at 44. The exemplary framework 13 encloses both cavities 42, 44 respectively with the housing 16, the fascia 18, and the door 20 of the ATM 10. The fascia 18 can be mounted on the framework 13 through hinges whereby the fascia 18 can pivotally move relative to the housing 16 and framework 13 to selectively open and close the upper cavity 42. It is noted that the HVAC unit 22 and the housing 16 have been omitted in FIG. 3 in order to better show other portions of the ATM 10. The exemplary ATM 10 includes a receipt printer 46 and escrow unit 48 positioned in the upper cavity 42. The exemplary ATM 10 also includes an upper currency note transport 50 (“upper transport 50”) positioned in the upper cavity 42. The exemplary receipt printer 46 is positioned above the upper transport 50 in the upper portion 86 of the interior of the ATM 10. The exemplary escrow unit 48 is positioned above the upper transport 50 and below the exemplary receipt printer 46. The exemplary upper transport 50 is configured to transport currency notes to and from the currency note input/output port 26, to and from the escrow unit 48 and also to and from a port 52 to be described in greater detail below. The exemplary upper transport 50 can include one or more motors, configured to impart motion to rotate one or more shafts, one or more wheels including vane wheels and/or rollers mounted on the one or more shafts, and one or more belts extending between shafts to transmit motion.

The exemplary ATM 10 includes a safe 54 defined by the lower cavity 44. The exemplary ATM 10 also includes cassettes 56, 56a, 56b positioned in the safe 54. The exemplary ATM 10 also includes a lower currency note transport 58 (“lower transport 58”) positioned in the lower cavity 44. The exemplary lower transport 58 is configured to transport currency notes to and from each cassette 56, 56a, 56b as well as to and from the port 52. The port 52 is an opening in the safe 54 and permits the movement of currency notes between the upper cavity 42 and lower cavity 44. The upper transport 50 and lower transport 58 exchange currency notes through/at the port 52. The exemplary lower transport 58 can include one or more motors, configured to impart motion to rotate one or more shafts, one or more wheels including vane wheels and/or rollers mounted on the one or more shafts, and one or more belts extending between shafts to transmit motion.

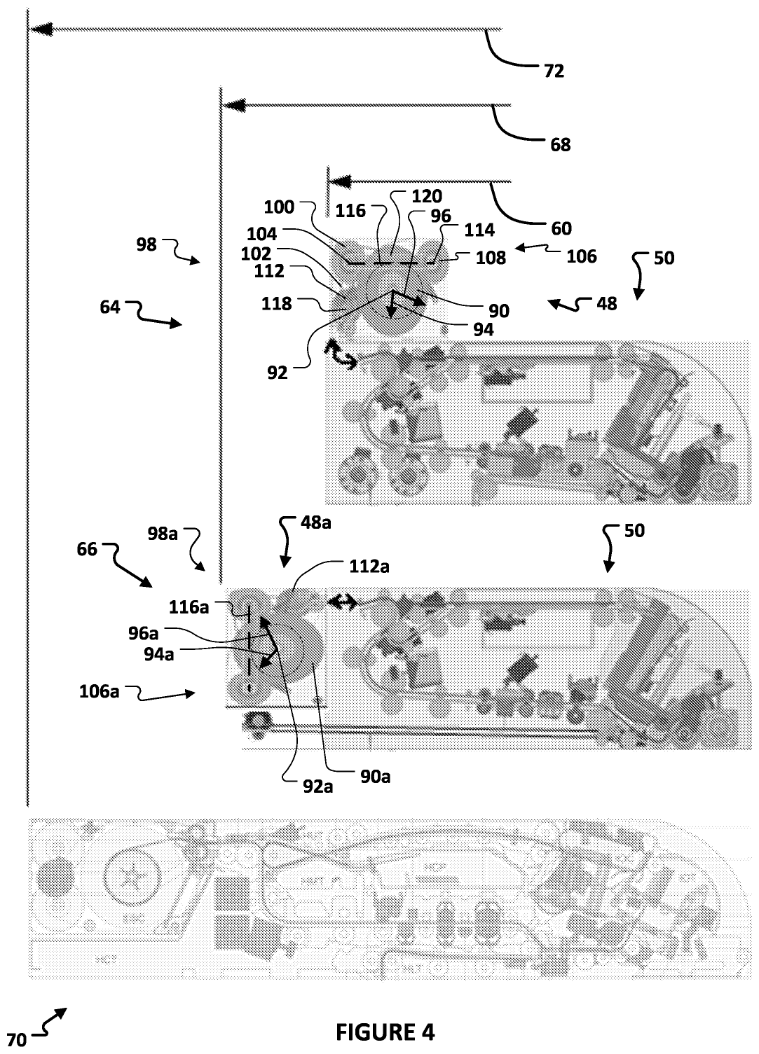

As shown in FIG. 3, the exemplary escrow unit 48 is positioned above the upper transport 50 to effectuate a minimal depth of the ATM 10. The depth of the ATM 10 is referenced at 60. The width of the ATM 10 is referenced at 78 in FIG. 2. As shown in FIG. 4, an escrow unit can be positioned at various positions and in various orientations relative to the upper transport 50 in order to accommodate particular depths for the ATM 10.

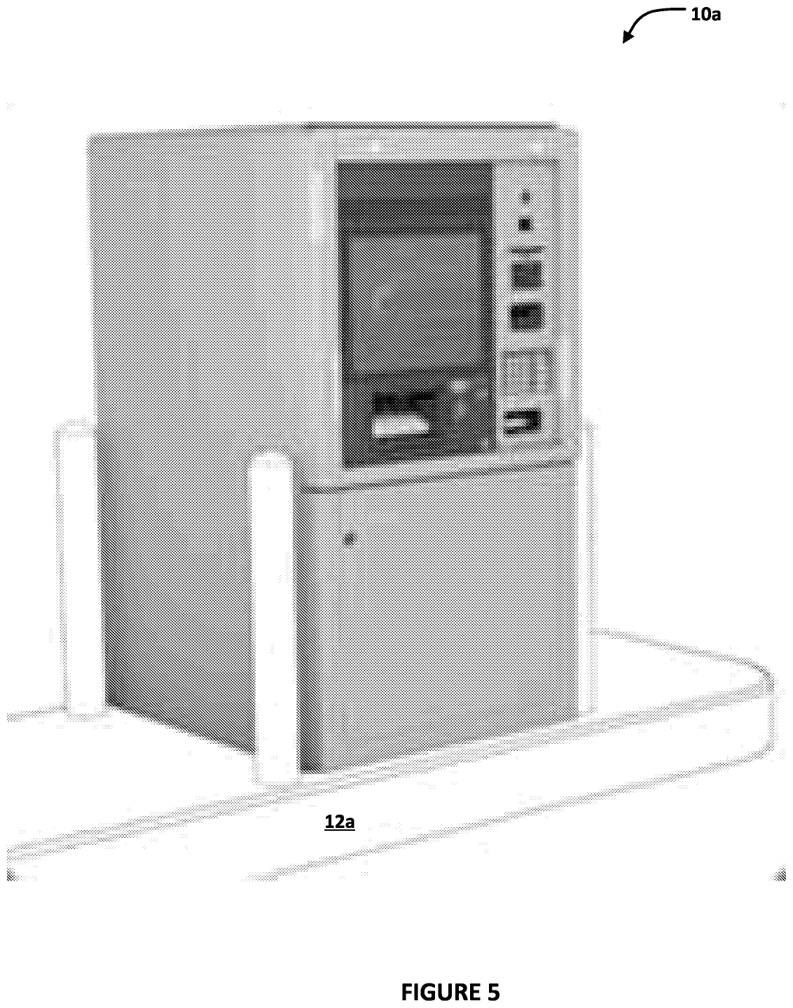

The arrangement of the upper transport 50 and the escrow unit 48 shown in FIG. 3 is referenced at 64 in FIG. 4 and corresponds to the depth 60. In an alternative arrangement referenced at 66 in FIG. 4, an escrow unit 48a is differently positioned and oriented relative to the escrow unit 48. The combined upper transport 50 and escrow unit 48a corresponds to an ATM depth referenced at 68. The arrangement 66 can be applied in an ATM 10a positioned on an island 12a and shown in FIG. 5. FIG. 4 also shows, referenced at 70, a combined upper transport and escrow unit in the prior art having a depth 72 for comparison.

Referring again to FIG. 4 and the arrangement 64, the exemplary escrow unit 48 is configured to receive and hold currency notes. The exemplary escrow unit 48 includes a drum 90, a first web-supply spool assembly 98, a second web-supply spool assembly 106, and a motor 112. The exemplary drum 90 is configured to collect currency notes received from the upper transport 50 and release collected currency notes to the upper transport 50. The exemplary drum 90 is rotatable about a first axis 92. The exemplary drum 90 has a variable radius including a minimum radius 94 when no currency notes are collected on the exemplary drum 90 and a maximum radius 96 when a maximum amount of currency notes are collected on the exemplary drum 90.

The exemplary first web-supply spool assembly 98 includes a first web-supply spool 100 and first web 102 wound around the first web-supply spool 100. The exemplary first web-supply spool 100 is configured to rotate about a second axis 104 that is parallel to and spaced from the first axis 92. The exemplary first web-supply spool assembly 98 is configured to rotate in unison with the exemplary drum 90 whereby the first web 102 is unwound from the first web-supply spool 100 and wound around the exemplary drum 90 to overlay currency notes as currency notes are collected on the exemplary drum 90. Similarly, the first web 102 is wound on the first web-supply spool 100 and unwound from the exemplary drum 90 as currency notes are removed from the exemplary drum 90.

The exemplary second web-supply spool assembly 106 including a second web-supply spool 108 and second web (not visible) wound around the second web-supply spool 108. A belt 120 interconnects the first web-supply spool assembly 98 and the second web-supply spool assembly 106 for concurrent rotation. The exemplary second web-supply spool 108 is configured to rotate about a third axis 114 parallel to and spaced from the second axis 104. The exemplary second web-supply spool assembly 106 is configured to rotate in unison with the exemplary drum 90 whereby the second web is unwound from the second web-supply spool 108 and wound around the exemplary drum 90 and overlay currency notes as currency notes are collected on the exemplary drum 90. Similarly, the second web is wound on the second web-supply spool 108 and unwound from the exemplary drum 90 as currency notes are removed from the exemplary drum 90. For example, currency notes can be positioned between the first web 102 and second web and when collected on the exemplary drum 90.

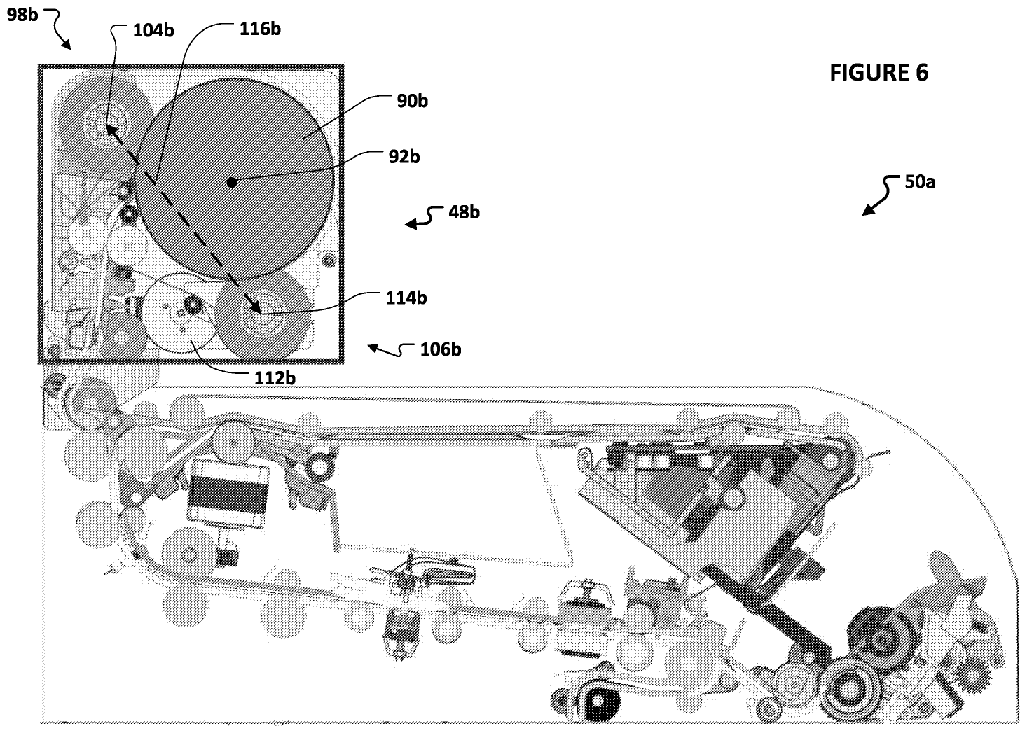

The exemplary motor 112 is configured to drive the exemplary drum 90 and the exemplary first web-supply spool 100 and the exemplary second web-supply spool 108 in rotation. The exemplary motor 112 is centered on a fifth axis 118. The exemplary fifth axis 118 is further from the exemplary first axis 92 than the maximum radius 96 of the exemplary drum 90, as best shown in FIG. 6. The exemplary drum 90 and the exemplary first web-supply spool 100 and the exemplary second web-supply spool 108 can be mounted on respective shafts (not referenced in the Figures) moved in rotation directly or indirectly by the motor 112.

An exemplary fourth axis 116 extends normal to and intersects both of the second axis 104 and the third axis 114. The exemplary fourth axis 116 is closer to the first axis 92 than the maximum radius 96 of the exemplary drum 90. The exemplary fourth axis 116 extends fully horizontally and is thus parallel to the depth axis 60. The exemplary first axis 92 is positioned closest to the upper transport 50 and the lower transport 58 among the exemplary first axis 92 and the exemplary second axis 104 and the exemplary third axis 114.

Referring again to FIG. 4 and the arrangement 66, the exemplary escrow unit 48a is configured to receive and hold currency notes. The exemplary escrow unit 48a includes a drum 90a, a first web-supply spool assembly 98a, a second web-supply spool assembly 106a, and a motor 112a. The exemplary drum 90a is configured to collect currency notes received from the upper transport 50 and release collected currency notes to the upper transport 50. The exemplary drum 90a is rotatable about a first axis 92a. The exemplary drum 90a has a variable radius including a minimum radius 94a when no currency notes are collected on the exemplary drum 90a and a maximum radius 96a when a maximum amount of currency notes are collected on the exemplary drum 90a.

It is noted that the exemplary escrow unit 48a is structurally identical to the exemplary escrow unit 48. The exemplary escrow unit 48a and the exemplary escrow unit 48 are differentiated by position and orientation relative to the upper transport 50, as shown in FIG. 4. The exemplary escrow unit 48a is positioned behind the upper transport 50 along the depth axis and is rotated relative to the exemplary escrow unit 48.

In the exemplary arrangement 66, an exemplary fourth axis 116a is closer to the exemplary first axis 92a than the maximum radius 96a of the exemplary drum 90a. The exemplary first axis 92a is positioned closest to the upper transport 50 among the exemplary first axis 92a and the axis of rotation of the first web spool assembly and the axis of rotation of the second web spool assembly. The exemplary first axis 92a will thus be positioned closest to a lower transport as well among the exemplary first axis 92a and the axis of rotation of the first web spool assembly and the axis of rotation of the second web spool assembly. The exemplary fourth axis 116a extends fully vertically and thus extends parallel to the height axis, transverse to the height axis.

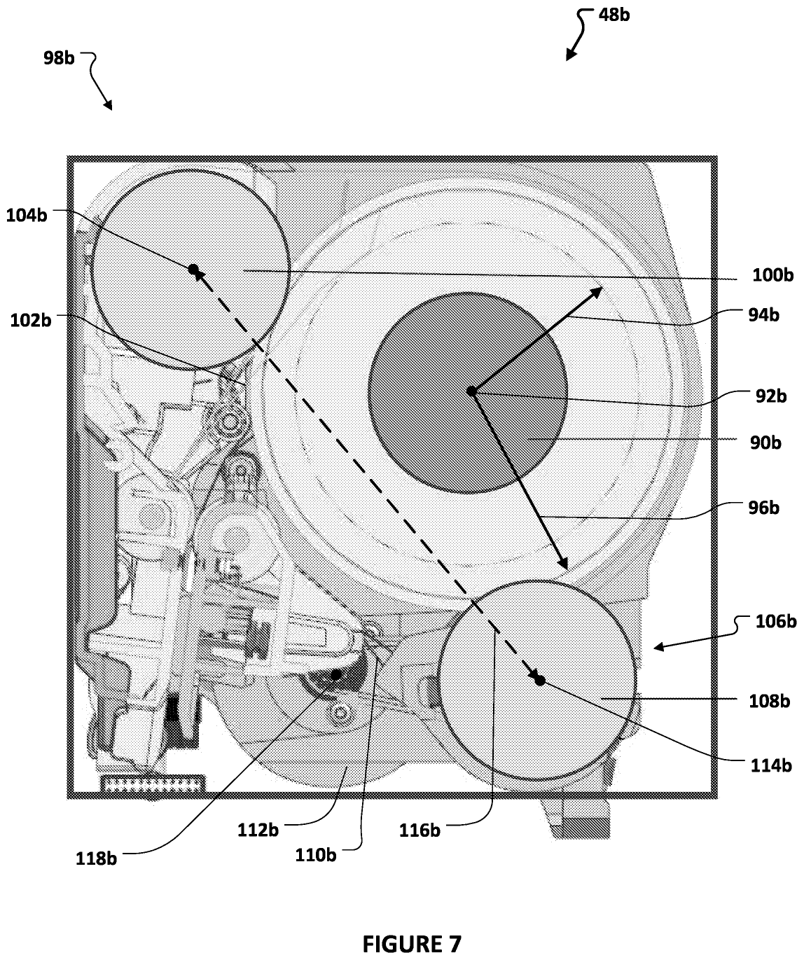

Referring now to FIGS. 6 and 7, an exemplary escrow unit 48b is configured to receive and hold currency notes. The exemplary escrow unit 48b includes a drum 90b, a first web-supply spool assembly 98b, a second web-supply spool assembly 106b, and a motor 112b. The exemplary drum 90b is configured to collect currency notes received from the upper transport 50a and release collected currency notes to the upper transport 50a. The exemplary drum 90b is rotatable about a exemplary first axis 92b. The exemplary drum 90b has a variable radius including a minimum radius 94b when no currency notes are collected on the exemplary drum 90b and a maximum radius 96b when a maximum amount of currency notes are collected on the exemplary drum 90b.

The exemplary first web-supply spool assembly 98b includes a first web-supply spool 100b and first web 102b wound around the first web-supply spool 100b. The exemplary first web-supply spool 100b is configured to rotate about a exemplary second axis 104b that is parallel to and spaced from the exemplary first axis 92b. The exemplary first web-supply spool assembly 98b is configured to rotate in unison with the exemplary drum 90b whereby the first web 102b is unwound from the first web-supply spool 100b and wound around the exemplary drum 90b to overlay currency notes as currency notes are collected on the exemplary drum 90b. Similarly, the first web 102b is wound on the first web-supply spool 100b and unwound from the exemplary drum 90b as currency notes are removed from the exemplary drum 90b.

The exemplary second web-supply spool assembly 106b including a second web-supply spool 108b and second web 110b wound around the second web-supply spool 108b. The exemplary second web-supply spool 108b is configured to rotate about a exemplary third axis 114b parallel to and spaced from the exemplary second axis 104b. The exemplary second web-supply spool assembly 106b is configured to rotate in unison with the exemplary drum 90b whereby the second web 110b is unwound from the second web-supply spool 108b and wound around the exemplary drum 90b and overlay currency notes as currency notes are collected on the exemplary drum 90b. Similarly, the second web 110b is wound on the second web-supply spool 108b and unwound from the exemplary drum 90b as currency notes are removed from the exemplary drum 90b. For example, currency notes can be positioned between the first and second webs 102b and 110bs when collected on the exemplary drum 90b.

The exemplary motor 112b is configured to drive the exemplary drum 90b and the exemplary first web-supply spool 100b and the exemplary second web-supply spool 108b in rotation. The exemplary motor 112b is centered on a fifth axis 118b. The exemplary fifth axis 118b is further from the exemplary first axis 92b than the maximum radius 96b of the exemplary drum 90b, as best shown in FIG. 6. The exemplary drum 90b and the exemplary first web-supply spool 100b and the exemplary second web-supply spool 108b can be mounted on respective shafts (not referenced in the Figures) moved in rotation directly or indirectly by the motor 112b.

An exemplary fourth axis 116b extends normal to and intersects both of the exemplary second axis 104b and the exemplary third axis 114b. The exemplary fourth axis 116b is closer to the exemplary first axis 92b than the maximum radius 96b of the exemplary drum 90b. The exemplary fourth axis 116b is closer to the exemplary first axis 92b than the minimum radius 94b of the exemplary drum 90b. The exemplary first axis 92b is positioned further from the upper transport 50a than at least one of the exemplary second axis 104b and the exemplary third axis 114b. The exemplary first axis 92b is thus positioned further from the lower transport than at least one of the exemplary second axis 104b and the exemplary third axis 114b as well. The exemplary escrow unit 48b is positioned above the upper transport 50a and the exemplary fourth axis 116b extends both vertically and horizontally, transverse to the depth axis.

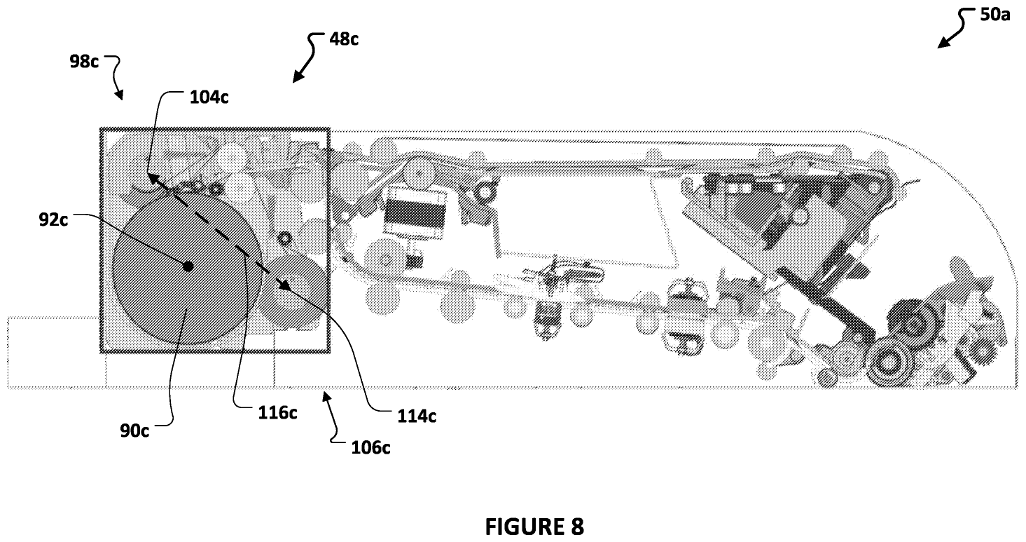

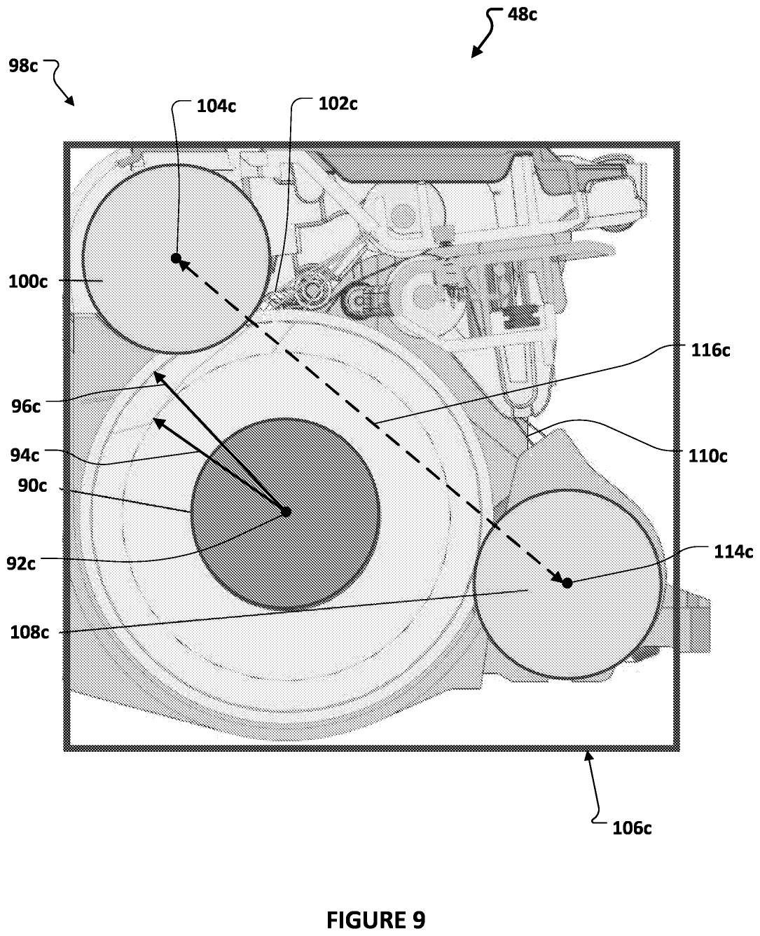

Referring now to FIGS. 8 and 9, the exemplary escrow unit 48c is configured to receive and hold currency notes. The exemplary escrow unit 48c includes a drum 90c, a first web-supply spool assembly 98c, a second web-supply spool assembly 106c, and a motor (not visible). The exemplary drum 90c is configured to collect currency notes received from the upper transport 50a and release collected currency notes to the upper transport 50a. The exemplary drum 90c is rotatable about a first axis 92c. The exemplary drum 90c has a variable radius including a minimum radius 94c when no currency notes are collected on the exemplary drum 90c and a maximum radius 96c when a maximum amount of currency notes are collected on the exemplary drum 90c.

The exemplary first web-supply spool assembly 98c includes a first web-supply spool 100c and first web 102c wound around the first web-supply spool 100c. The exemplary first web-supply spool 100c is configured to rotate about a second axis 104c that is parallel to and spaced from the first axis 92c. The exemplary first web-supply spool assembly 98c is configured to rotate in unison with the exemplary drum 90c whereby the first web 102c is unwound from the first web-supply spool 100c and wound around the exemplary drum 90c to overlay currency notes as currency notes are collected on the exemplary drum 90c. Similarly, the first web 102c is wound on the first web-supply spool 100c and unwound from the exemplary drum 90c as currency notes are removed from the exemplary drum 90c.

The exemplary second web-supply spool assembly 106c including a second web-supply spool 108c and second web 110c wound around the second web-supply spool 108c. The exemplary second web-supply spool 108c is configured to rotate about a third axis 114c parallel to and spaced from the second axis 104c. The exemplary second web-supply spool assembly 106c is configured to rotate in unison with the exemplary drum 90c whereby the second web 110c is unwound from the second web-supply spool 108c and wound around the exemplary drum 90c and overlay currency notes as currency notes are collected on the exemplary drum 90c. Similarly, the second web 110c is wound on the second web-supply spool 108c and unwound from the exemplary drum 90c as currency notes are removed from the exemplary drum 90c. For example, currency notes can be positioned between the first and second webs 102c and 110cs when collected on the exemplary drum 90c.

The exemplary motor is configured to drive the exemplary drum 90c and the exemplary first web-supply spool 100c and the exemplary second web-supply spool 108c in rotation. The exemplary motor is centered on a fifth axis. The exemplary fifth axis is further from the exemplary first axis 92c than the maximum radius 96c of the exemplary drum 90c, as best shown in FIG. 6. The exemplary drum 90c and the exemplary first web-supply spool 100c and the exemplary second web-supply spool 108c can be mounted on respective shafts (not referenced in the Figures) moved in rotation directly or indirectly by the motor.

An exemplary fourth axis 116c extends normal to and intersects both of the second axis 104c and the third axis 114c. The exemplary fourth axis 116c is closer to the first axis 92c than the maximum radius 96c of the exemplary drum 90c. The exemplary fourth axis 116c is closer to the first axis 92c than the minimum radius 94c of the exemplary drum 90c. The exemplary first axis 92c is positioned further from the upper transport 50a than at least one of the second axis 104c and the third axis 114c. The exemplary first axis 92c is thus positioned further from the lower transport than at least one of the second axis 104c and the third axis 114c. The exemplary escrow unit 48c is positioned behind the upper transport 50a along a depth axis and the fourth axis 116c extends both vertically and horizontally, transverse to the height axis.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventors and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings.

What is claimed is:

1. An automated transaction machine (“ATM”) comprising:
a first currency note input/output port;
an escrow unit configured to receive and hold currency notes;
an upper transport configured to transport currency notes to and from said first currency note input/output port and to and from said escrow unit; and
wherein said escrow unit further comprises:
a drum configured to collect currency notes received from said upper transport and release collected currency notes to said upper transport, said drum rotatable about a first axis, said drum having a variable radius including a minimum radius when no currency notes are collected on said drum and a maximum radius when a maximum amount of currency notes are collected on said drum,
a first web-supply spool assembly including a first web-supply spool and first web wound around said first web-supply spool, said first web-supply spool configured to rotate about a second axis parallel to and spaced from said first axis, said first web-supply spool assembly configured to rotate in unison with said drum whereby said first web is unwound from said first web-supply spool and wound around said drum to overlay currency notes as currency notes are collected on said drum and whereby said first web is wound on said first web-supply spool and unwound from said drum as currency notes are removed from said drum,
a second web-supply spool assembly including a second web-supply spool and second web wound around said second web-supply spool, said second web-supply spool configured to rotate about a third axis parallel to and spaced from said second axis, said second web-supply spool assembly configured to rotate in unison with said drum whereby said second web is unwound from said second web-supply spool and wound around said drum and overlay currency notes as currency notes are collected on said drum and whereby said second web is wound on said second web-supply spool and unwound from said drum as currency notes are removed from said drum, and
wherein a fourth axis extends normal to and intersects both of said second axis and said third axis and said fourth axis is closer to said first axis than said maximum radius of said drum.

2. The ATM of claim 1 wherein said fourth axis is closer to said first axis than said minimum radius of said drum.

3. The ATM of claim 1 wherein said escrow unit is positioned above said upper transport and said fourth axis extends fully horizontally.

4. The ATM of claim 1 wherein said escrow unit is positioned behind said upper transport and said fourth axis extends fully vertically.

5. The ATM of claim 1 wherein said escrow unit is positioned above said upper transport and said fourth axis extends both vertically and horizontally.

6. The ATM of claim 1 wherein said escrow unit is positioned behind said upper transport and said fourth axis extends both vertically and horizontally.

7. The ATM of claim 1 wherein said first axis is positioned closest to said upper transport among said first axis and said second axis and said third axis.

8. The ATM of claim 1 wherein said first axis is positioned further from said upper transport than at least one of said second axis and said third axis.

9. The ATM of claim 1 further comprising:
a belt interconnecting said first web-supply spool assembly and said second web-supply spool assembly for concurrent rotation.

10. An automated transaction machine (“ATM”) comprising:
a framework including a horizontal wall;
a housing mounted on said framework and extending vertically along a height axis between a top and a bottom, horizontally along a depth axis between a front and a back, and also horizontally along a width axis between a first lateral side and a second lateral side;
a fascia mounted on said framework and cooperating with said horizontal wall to define an upper portion of an interior of said ATM;
a display positioned in a first aperture of said fascia;
a first currency note input/output port positioned in a second aperture of said fascia;
a door mounted on said framework and cooperating with said horizontal wall to define a lower portion of said interior as well as a safe of said ATM;
a plurality of cassettes positioned in said safe;
a second currency note input/output port extending through said horizontal wall;
a lower transport positioned in said safe and configured to transport currency notes between said second currency note input/output port and said plurality of cassettes;
an escrow unit configured to receive and hold currency notes;
an upper transport positioned in said upper cavity and configured to transport currency notes to and from said first currency note input/output port, to and from said second currency note input/output port, and to and from said escrow unit; and
wherein said escrow unit further comprises:
a drum configured to collect currency notes received from said upper transport and release collected currency notes to said upper transport, said drum rotatable about a first axis, said drum having a variable radius including a minimum radius when no currency notes are collected on said drum and a maximum radius when a maximum amount of currency notes are collected on said drum,
a first web-supply spool assembly including a first web-supply spool and first web wound around said first web-supply spool, said first web-supply spool configured to rotate about a second axis parallel to and spaced from said first axis, said first web-supply spool assembly positioned adjacent to said drum and configured to rotate in unison with said drum whereby said first web is unwound from said first web-supply spool and wound around said drum and overlay currency notes as currency notes are collected on said drum and whereby said first web is wound on said first web-supply spool and unwound from said drum as currency notes are removed from said drum,
a second web-supply spool assembly including a second web-supply spool and second web wound around said second web-supply spool, said second web-supply spool configured to rotate about a third axis parallel to and spaced from said second axis, said second web-supply spool assembly positioned adjacent to said drum and configured to rotate in unison with said drum whereby said second web is unwound from said second web-supply spool and wound around said drum and overlay currency notes as currency notes are collected on said drum and whereby said second web is wound on said second web-supply spool and unwound from said drum as currency notes are removed from said drum, and
wherein a fourth axis extends normal to and intersects both of said second axis and said third axis and said fourth axis is closer to said first axis than said maximum radius of said drum.

11. The ATM of claim 10 wherein said escrow unit is positioned above said upper transport and said fourth axis extends parallel to said depth axis.

12. The ATM of claim 10 wherein said escrow unit is positioned behind said upper transport along said depth axis and said fourth axis extends parallel to said height axis.

13. The ATM of claim 10 wherein said escrow unit is positioned above said upper transport and said fourth axis extends transverse to said depth axis.

14. The ATM of claim 10 wherein said escrow unit is positioned behind said upper transport along said depth axis and said fourth axis extends transverse to said height axis.

15. The ATM of claim 10 further comprising:
a receipt printer positioned above said upper transport in said upper portion of said interior.

16. The ATM of claim 7 wherein said escrow unit is positioned above said upper transport and below said receipt printer.

17. The ATM of claim 10 wherein said first axis is positioned closest to said lower transport among said first axis and said second axis and said third axis.

18. The ATM of claim 10 wherein said first axis is positioned further from said lower transport than at least one of said second axis and said third axis.

19. The ATM of claim 10 further comprising:
a belt interconnecting said first web-supply spool assembly and said second web-supply spool assembly for concurrent rotation.

20. The ATM of claim 10 wherein said escrow unit further comprises:
a motor configured to drive said drum and said first web-supply spool and said second web-supply spool, said motor centered on a fifth axis, said fifth axis is further from said first axis than said maximum radius of said drum.
